(19) United States
(12) Patent Application Publication
(10) Pub. No.: US 2018/0293620 A1
(43) Pub. Date: Oct. 11, 2018

(54) INFORMATION RECOMMENDATION METHOD, TERMINAL, SERVER, AND COMPUTER STORAGE MEDIUM

(71) Applicant: TENCENT TECHNOLOGY (SHENZHEN) COMPANY LIMITED, Shenzhen (CN)

(72) Inventor: Mao Hua CHEN, Shenzhen (CN)

(73) Assignee: TENCENT TECHNOLOGY (SHENZHEN) COMPANY LIMITED, Shenzhen (CN)

(21) Appl. No.: 16/003,254

(22) Filed: Jun. 8, 2018

Related U.S. Application Data
(63) Continuation of application No. PCT/CN2017/081748, filed on Apr. 24, 2017.

(30) Foreign Application Priority Data
Apr. 27, 2016 (CN) 201610272172.3

(51) Int. Cl. G06Q 30/02; H04W 4/021

(52) U.S. Cl. CPC G06Q 30/0261; H04W 4/022; G06Q 30/0271

(57) ABSTRACT

A method and system that provides a user with precision and accuracy of recommended information that matches the user's personality and behavior by obtaining the location of the user's mobile terminal, determining a target area based on the location, the target area including more than one signal transmission source, each signal transmission source carrying an ID that represents the signal transmission source, and the ID carried in the signal transmission source being transmitted within a target range by using the signal transmission source, obtaining other information from the terminal including user basic information and/or user behavior information and/or user relation chain information, selecting target display information associated with this information from the display information associated with the more than one ID of the terminal, and sending the target display information to the terminal.

### CROSS-REFERENCE TO RELATED APPLICATION

This application is a continuation of International Application No. PCT/CN2017/081748, filed on Apr. 24, 2017, which claims priority from Chinese Patent Application No. 201610272172.3, entitled “INFORMATION RECOMMENDATION METHOD, TERMINAL, SERVER, AND COMPUTER STORAGE MEDIUM,” filed on Apr. 27, 2016, in the Chinese Patent Office, the disclosures of which are incorporated herein by reference in their entireties.

### BACKGROUND

### 1. Field

The present disclosure relates to information processing technologies, and in particular, to an information recommendation method, a terminal, a server, and a computer storage medium.

### 2. Description of Related Art

With the development of science and technologies, merchants use various methods to promote their services. For example, service messages are displayed by using application software. Among numerous promotion methods, an iBeacon technology is very popular. iBeacon is a micro positioning technology that is implemented by using a low-power Bluetooth technology and has high positioning precision. In actual application, a device with an iBeacon function (an iBeacon device) can send, to neighboring devices, an identifier (ID) of a service that a merchant can provide, and a device that receives the ID may execute some operations based on the ID. For example, an iBeacon device A broadcasts an ID of a service that a merchant can provide, and after detecting the ID of the iBeacon device A through a terminal that is within a certain distance from the iBeacon device A, the terminal may obtain the service corresponding to the ID from a server according to the ID and display the service locally. However, iBeacon has a limited broadcast distance for its signals and an application range is limited. Further, the products and services recommended by iBeacon to a terminal user do not incorporate the user's personality, and therefore the recommendation precision is poor.

### SUMMARY

It may be an aspect to provide an information recommendation method, a terminal, a server, and a computer storage medium, which can resolve the existing technical problem discussed above.

According to an aspect of one or more exemplary embodiments, there is provided an information recommendation method comprising obtaining first information from a terminal, the first information being used for representing a geographic location of the terminal; determining a target area based on the first information, the target area including more than one signal transmission source, each signal transmission source carrying an ID that represents the signal transmission source, and the ID carried in the signal transmission source being transmitted within a target range by using the signal transmission source; obtaining an ID corresponding to the more than one signal transmission source in the target area and display information associated with more than one ID; obtaining second information from the terminal, the second information at least including: user basic information and/or user behavior information and/or user relation chain information; selecting target display information associated with the second information from the display information associated with the more than one ID; and sending the target display information to the terminal.

According to an aspect of one or more exemplary embodiments, there is provided an information recommendation method comprising detecting first information of a terminal, the first information being used for representing a geographic location of the terminal; sending the first information and second information to a server, the second information at least including: user basic information and/or user behavior information and/or user relation chain information; receiving target display information sent by the server, the target display information being display information determined based on the first information and the second information.

According to an aspect of one or more exemplary embodiments, there is provided an apparatus comprising at least one memory configured to store computer program code; and at least one processor configured to access the at least one memory and operate according to the computer program code, said computer program code including a first obtaining unit configured to cause at least one of the at least one processor to obtain first information from a terminal, the first information being used for representing a geographic location of the terminal; a determining unit configured to cause at least one of the at least one processor to determine a target area based on the first information, the target area including more than one signal transmission source, each signal transmission source carrying an ID that represents the signal transmission source, and the ID carried in the signal transmission source being transmitted within a target range by using the signal transmission source; a second obtaining unit configured to cause at least one of the at least one processor to obtain an ID corresponding to the more than one signal transmission source in the target area and display information associated with more than one ID; a third obtaining unit configured to cause at least one of the at least one processor to obtain second information from the terminal, the second information at least including: user basic information and/or user behavior information and/or user relation chain information; a selection configured to cause at least one of the at least one processor to select target display information associated with the second information from the display information associated with the more than one ID; and a sending unit configured to cause at least one of the at least one processor to send the target display information to the terminal.

According to an aspect of one or more exemplary embodiments, there is provided a non-transitory computer-readable storage medium that stores computer program code that, when executed by a processor, causes the processor to execute a method comprising obtaining first information from a terminal, the first information being used for representing a geographic location of the terminal; determining a target area based on the first information, the target area including more than one signal transmission source, each signal transmission source carrying an ID that represents the signal transmission source, and the ID carried in the signal transmission source being transmitted within a target range by using the signal transmission source; obtaining an ID corresponding to the more than one signal transmission source in the target area and display information associated with more than one ID; obtaining second information from the terminal, the second information at least including: user basic information and/or user behavior information and/or user relation chain information; selecting target display information associated with the second information from the display information associated with the more than one ID; and sending the target display information to the terminal.

According to an aspect of one or more exemplary embodiments, there is provided a method comprising obtaining first information from a terminal, the first information being used for representing a geographic location of the terminal; determining a target area based on the first information, the target area including more than one signal transmission source, each signal transmission source carrying an ID that represents the signal transmission source, and the ID carried in the signal transmission source being transmitted within a target range by using the signal transmission source; obtaining an ID corresponding to the more than one signal transmission source in the target area and display information associated with more than one ID; obtaining second information from the terminal, the second information at least including: user basic information and/or user behavior information and/or user relation chain information; selecting target display information associated with the second information from the display information associated with the more than one ID; and sending the target display information to the terminal.

In this solution, an area within a range of geographical location of a terminal is used as a target area, and the scope of an area range is expanded, thereby increasing the amount of display information and enriching the content of the display to a user. Further, the target display information can be filtered from multiple pieces of display information based on an ID corresponding to a signal transmission source in the target area and in combination with second information (i.e., a user's personality), the recommendation precision and accuracy can be effectively improved.

### BRIEF DESCRIPTION OF THE DRAWINGS

The accompanying drawings described herein are used for providing further understanding for this application and constitute a part of this application. Example embodiments of this application and descriptions thereof are used for explaining this application and do not constitute an improper limitation to this application.

FIG. 1 is a schematic diagram of hardware entities of parties that perform information interactions according to an exemplary embodiment.

FIG. 2 is a schematic diagram of an implementation process of an information recommendation method that is applied to a terminal according to the first exemplary embodiment.

FIG. 3 is a schematic diagram of an implementation process of an information recommendation method that is applied to a server according to the first exemplary embodiment.

FIG. 4 is a schematic diagram of an implementation process of an information recommendation method that is applied to a terminal according to the second exemplary embodiment.

FIG. 5 is a schematic diagram of an implementation process of an information recommendation method that is applied to a server according to the second exemplary embodiment.

FIG. 6 is a schematic diagram of a composition structure of a terminal according to an exemplary embodiment.

FIG. 7 is a schematic diagram of a composition structure of a server according to an exemplary embodiment.

FIG. 8 is a schematic diagram of a composition structure of a terminal according to an exemplary embodiment.

FIG. 9 is a schematic diagram of a composition structure of a server according to an exemplary embodiment.

FIG. 10 is a schematic structural diagram of a hardware structure of a terminal and a server according to an exemplary embodiment.;

FIG. 11 is a schematic diagram of a server recording a correspondence according to an exemplary embodiment.

FIG. 12 is a schematic diagram of an application scenario according to an exemplary embodiment.

FIG. 13(a) to FIG. 13(d) are schematic diagrams of a terminal displaying target display information according to exemplary embodiments.

FIG. 14(a) and FIG. 14(b) are schematic diagrams of a terminal displaying target display information according to exemplary embodiments.

### DETAILED DESCRIPTION OF THE EXAMPLE EMBODIMENTS

The following describes preferred exemplary embodiments of the present disclosure in detail with reference to the accompanying drawings. It should be understood that, the following described preferred exemplary embodiments are merely used to describe and explain the present disclosure, and are not used to limit the present disclosure. It should note that the exemplary embodiments to be described are some rather than all of the exemplary embodiments of this application. All other embodiments obtained by a person skilled in the art based on the example embodiments of the present application without creative efforts shall fall within the protection scope of the present application.

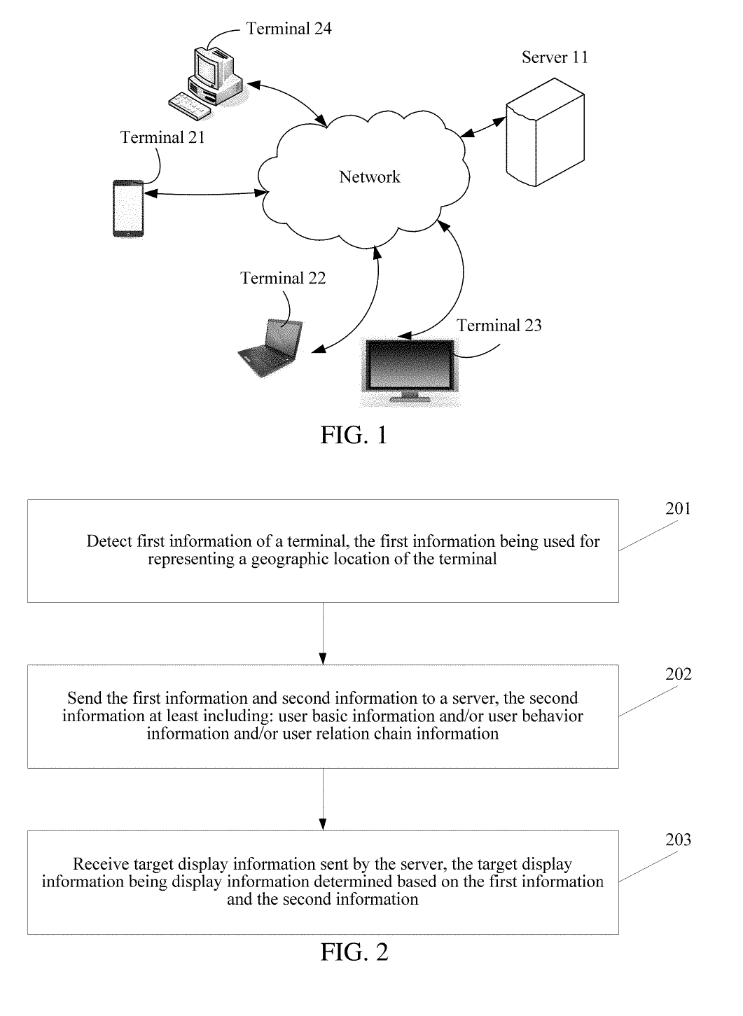

FIG. 1 is a schematic diagram of hardware entities of parties that perform information interactions according to an exemplary embodiment of the present disclosure. FIG. 1 may include a server 11 and terminals 21 to 24. The terminals 21 to 24 perform information interactions with the server by using a wired network or a wireless network. The terminal may be a mobile phone, a desktop, a personal computer, an all-in-one machine, or the like. Certainly, the terminal may also be a personal digital assistant (PDA), an e-reader, or the like. This is not specifically limited in this solution. The terminal detects first information, the first information being used for representing a geographic location of the terminal, and sends information about the detected geographic location and second information to the server, the second information at least including: user basic information and/or user behavior information and/or user relation chain information. The server receives the first information and the second information, determines a target area based on the first information, and obtains an ID corresponding to more than one signal transmission source in the target area and display information associated with more than one ID, and selects target display information associated with the second information from the display information associated with the more than one ID, and sends the target display information to the terminal. The terminal receives the target display information sent by the server. In this exemplary embodiment, the server determines the target display information based on the geographic location of the terminal and the second information that can represent a user personality, and sends the target display information to the terminal, so that the terminal receives the target display information. The display information is recommended based on the geographic location of the terminal, and the server expands a geographic range, thereby increasing the quantity of recommendations of the display information, and enriching display content. The recommended display information incorporates a user's personality so that the recommended information is more precise and accurate because it meets the user's personality and actual requirements, improving the overall user experience.

The example in FIG. 1 is an instance of a system architecture for implementing according to the exemplary embodiments. The exemplary embodiments are not limited to the system architecture in FIG. 1.

### Exemplary Embodiment 1

An information recommendation method applied to a terminal according to the first exemplary embodiment, as shown in FIG. 2, the method may include the following steps 201 to 203.

In step 201, a first information of a terminal is detect, the first information is used for representing a geographic location of the terminal.

Herein, the terminal includes a geographic location detection module, and detects a current geographic location of the terminal by using the geographic location detection module. The geographic location detection module may be a global positioning system (GPS), a geographic information system (GIS), or the like.

In an exemplary embodiment, when receiving a first operation and/or detecting that a location of the terminal changes, the terminal detects the first information of the terminal. The first operation may be in any form of the operation in connection with the terminal such as shaking and/or waving the terminal; or may be a non-touch or touch operation for a touch screen of the terminal such as clicking, pressing, sliding or the like. When the location of the terminal changes, the current geographic location of the terminal may be detected by using the geographic location detection module.

In step 202, the first information and a second information are sent to a server, the second information may include user basic information and/or user behavior information and/or user relation chain information or the like.

Herein, after detecting the first information, the terminal sends the first information and the second information to the server. The user basic information may be gender, age, occupation and/or the like of a terminal user. The user behavior information is information gained from the user's use of a terminal. The information may include, but is not limited to the information following a merchant, information following a public account, or information participating in a scanning activity pushed by a merchant. The user relation chain information may be information that can represent a social circle of a user, such as a friend group of the user, a family group of the user, or the like.

In step 203, target display information sent by the server is receive, the target display information is display information determined based on the first information and the second information.

Herein, the terminal sends the first information and the second information to the server. The server will then process the first information and the second information in order to obtain the target display information. The terminal receives the target display information once the server sends it.

An information recommendation method according to an exemplary embodiment may further include terminal displays the target display information. After receiving the target display information, the terminal displays the target display information in a preset display form. For example, a display unit of the terminal directly displays the target display information; and loads the target display information to a preset display template for display, such as displaying a PPT form; or may display the target display information by using social software. The display form may be any form that can be thought of by a person skilled in the art. Other display forms that can be thought of are not described again because the forms cannot be exhaustive.

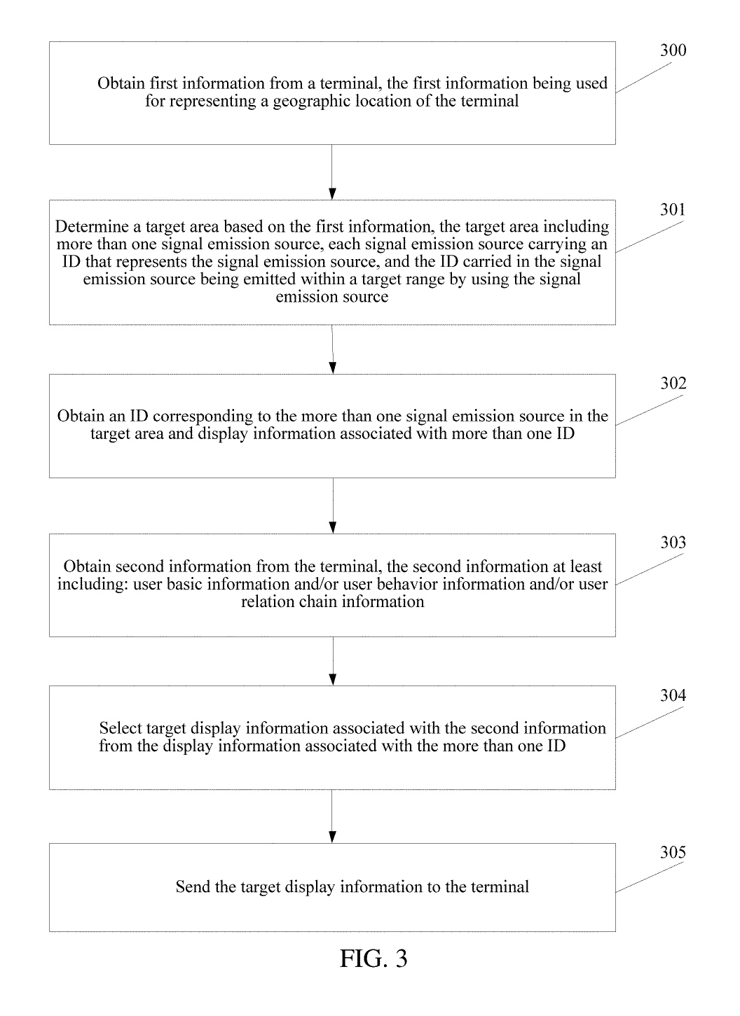

An information recommendation method applied to a server according to the first exemplary embodiment, as shown in FIG. 3, the method may include the following steps 300 to 305.

In step 300, first information from a terminal is received, the first information is used for representing a geographic location of the terminal.

Herein, the server receives a current geographic location information of the terminal from the terminal.

In step 301, a target area is determined based on the first information. The target area includes more than one signal transmission source. Each of the signal transmission sources includes an ID that represents the signal transmission source, and the ID carried in the signal transmission source is transmitted within a target range by using the signal transmission source.

In step 302, an ID corresponding to the more than one signal transmission sources in the target area is obtained and information associated with more than one ID is displayed.

In an exemplary embodiment, step 301 may be further comprises: determining an area where a distance from the standard area meets a first preset condition as the target area by using the geographic location as a standard area. Correspondingly, step 302 may be further comprises: determining more than one signal transmission source in the target area; determining an ID corresponding the more than one signal transmission sources, obtaining more than one ID; and determining display information corresponding to the more than one ID as the associated display information.

Herein, the signal transmission source may be an iBeacon device, a non-touch hardware device that can emit information, or the like. Each iBeacon device has an ID, and an ID corresponding to the iBeacon is an ID of the iBeacon device. The server uses the current geographic location of the terminal as a center, and uses an area in a range within a distance from the center as a target area. The size of the range may be set flexibly based on an actual situation. For example, an area of a circumference of 200 m of the center is used as the target area, or an area of a circumference of 1000 m of the center is used as the target area. Generally, in actual application, at least one store (merchant) exists in the target area, each store may have an iBeacon device, each device has an exclusive ID, and the ID of each iBeacon device is allocated by the server. After receiving the ID allocated by the server, the iBeacon device may emit the ID within a target range. For example, the iBeacon device may emit the ID within a circumference of 50 m, to spread services provided by the iBeacon device. The server may record a correspondence between each ID and service content, namely, display information, provided by a corresponding store. The server reads the ID of each iBeacon device in the target area, and determines, according to the correspondence, a service provided by each store in the target area. The service content provided by the store may be regarded as display information. For example, an iBeacon device of a store A in the target area is an ID 1, and the device may emit the ID 1 to spread the service content provided by the device. For the server, the server may learn, according to the ID 1 and the recorded correspondence, that the device provides a buy-one get-one-free service, and the display information is a “buy-one get-one-free coupon”.

In step 303, second information from the terminal is received, the second information may include: user basic information and/or user behavior information and/or user relation chain information, or the like.

Herein, the second information of the terminal may or may not be stored in the server. When the server does not store the second information, the server receives the second information from the terminal. When the server stores the second information, the server may receive the second information from the terminal, or may read the stored second information from the terminal according to an ID of the terminal. The ID of the terminal may be an International Mobile Equipment Identity (IMEI) of a subscriber identity module card inserted by the terminal, a Mobile Equipment Identifier (MEID), a media access control (MAC) address used by the terminal, or the like.

It should be noted that, the sequence of performing step 302 and step 303 is not strictly limited. Step 303 may be performed first and then step 302 can be performed second, or step 302 and step 303 may be performed at the same time.

In step 304:,target display information associated with the second information is selected from the display information associated with the more than one ID.

Herein, the second information is information that can represent a personality of a terminal user. The server filters, from multiple pieces of display information, display information (target display information) that can represent a personality of a terminal user or an actual use situation.

In step 305, the target display information is sent to the terminal.

Herein, after filtering the target display information, the server provides the target display information to the terminal. Correspondingly, the terminal receives the target display information.

It can be learnt from the foregoing solution that, a terminal sends, to a server, detected first information that can represent a geographic location of the terminal and detected second information that can represent a personality of a terminal user, the server determines a target area according to the geographic location of the terminal, and determines, according to an ID of an iBeacon device in the target area, services, namely, display information, provided by all stores (merchants) in the target area. The server filters, in combination with the second information that can represent the personality of the terminal user and from the determined display information, display information expected by the terminal user, namely, target display information, and provides the target display information to the terminal. The terminal receives and displays the target display information. The server uses an area in a range within a distance from the geographic location of the terminal as the target area, and determines display information associated with more than one ID in the target area as display information that may be initially recommended. Compared with a limited broadcast distance of an iBeacon signal in the related technology, in this solution, an area range is expanded so that the amount of display information can be increased and the display content can be enriched. The target display information is filtered from the display information that may be initially recommended and in combination with the second information, namely, in combination with a user personality, to recommend the information expected by the terminal user. The recommended display information can then meet an actual requirement of the user and greatly improve the recommendation's precision and accuracy, as well as improving user experience.

### Exemplary Embodiment 2

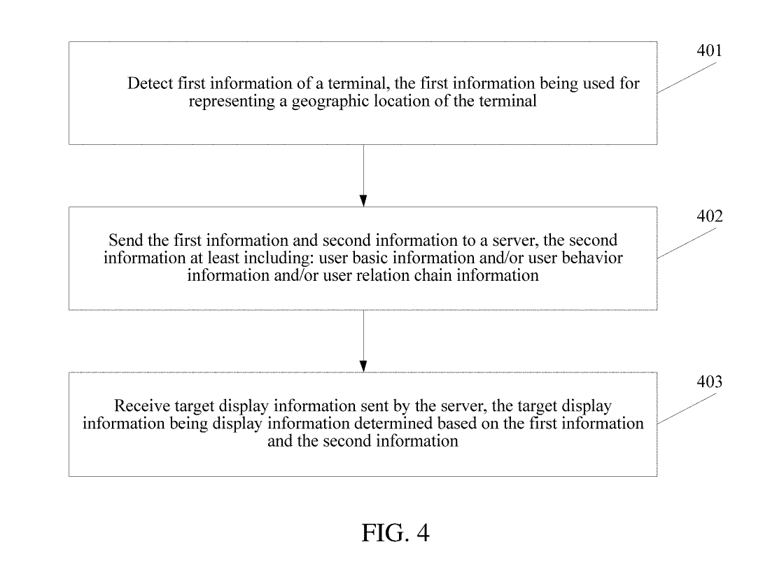

An information recommendation method applied to a terminal according to the second exemplary embodiment, as shown in FIG. 4, the method may include the following steps 401 to 403, as an exemplary embodiment.

In step 401, first information of a terminal is detected, the first information is used for representing a geographic location of the terminal.

Herein, the terminal has a geographic location detection module, and detects a current geographic location of the terminal by using the geographic location detection module. The geographic location detection module may be a GPS, a GIS, or the like.

In an exemplary embodiment, when receiving a first operation and/or detecting that a location of the terminal changes, the terminal detects the first information of the terminal. The first operation may be in any form of the operation in connection with the terminal such as shaking and/or waving the terminal; or may be a non-touch or touch operation for a touch screen of the terminal such as clicking, pressing, and/or sliding, or the like. When the location of the terminal changes, the current geographic location of the terminal may be detected by using the geographic location detection module.

In step 402, the first information and second information are sent to a server, and the second information at least includes: user basic information and/or user behavior information and/or user relation chain information.

Herein, after detecting the first information, the terminal sends the first information and the second information to the server. The user basic information may be gender, age, occupation and the like of a terminal user. The user's behavior information is information gained from user's use of a terminal, such as following a public account of a merchant, or participating a scanning activity pushed by a merchant. The user relation chain information may be information that can represent a social circle of a user, such as a friend group of the user or a family group of the user.

In step 403, target display information sent by the server is received, the target display information is determined based on the first information and the second information.

Herein, the terminal sends the first information and the second information to the server. The server then processes the first information and the second information in order to obtain the target display information. When the server sends the target display information to the terminal, the terminal receives the target display information once the server sends the target display information.

An information recommendation method according to an exemplary embodiment may further include terminal displays that display the target display information. The terminal displays the target display information in a preset display form after receiving the target display information. For example, a display unit of the terminal directly displays the target display information; it loads the target display information to a preset display template for display, such as displaying a PPT form; or may display the target display information by using social software. The display form may be any form that can be thought out by a person skilled in the art. Other display forms that can be thought of are not described again because the forms cannot be exhaustive.

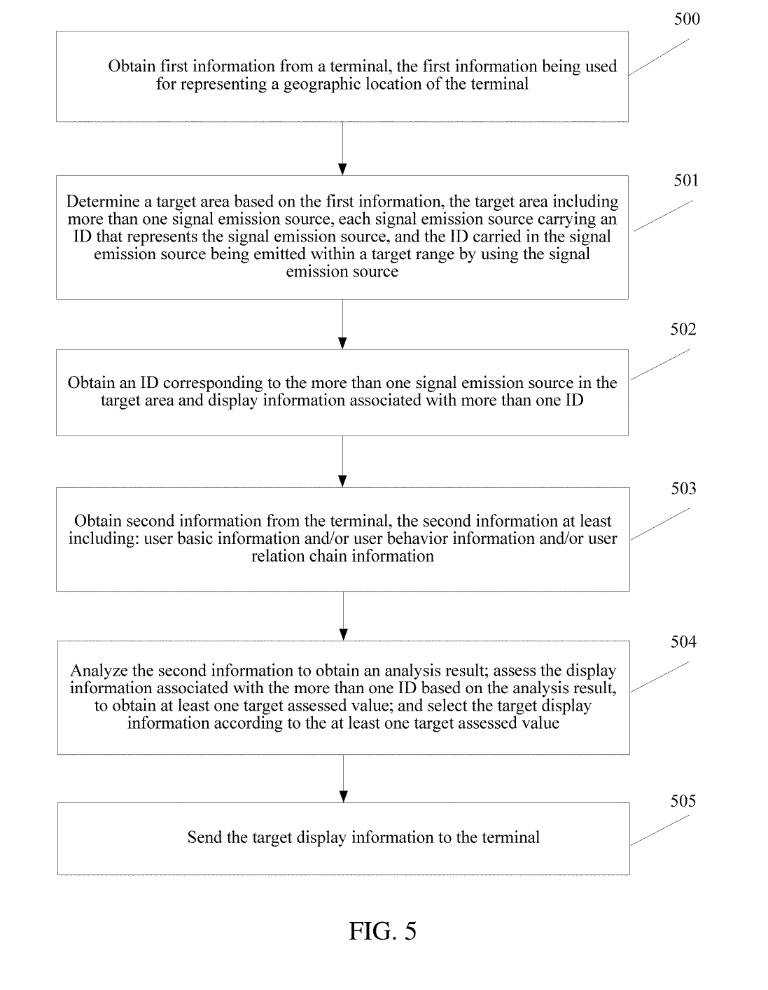

An information recommendation method applied to a server according to the second exemplary embodiment, as shown in FIG. 5. The method may include the following steps 500 to 505.

In step 500: first information from a terminal is received, the first information is used for representing a geographic location of the terminal.

Herein, the server receives a current geographic location information of the terminal from the terminal.

In step 501, a target area based on the first information is determined, the target area may include more than one signal transmission source, each signal transmission source carries an ID that represents the signal transmission source, and the ID carried in the signal transmission source is transmitted within a target range by using the signal transmission source.

In step 502, an ID corresponding to the more than one signal transmission source in the target area is obtained and information associated with more than one ID is displayed.

In an exemplary embodiment, step 501 may be further determining an area where a distance from the standard area meets a first preset condition as the target area by using the geographic location as a standard area. Correspondingly, step 502 may be further: determining more than one signal transmission source in the target area; determining the IDs corresponding of more than one signal transmission sources, obtaining more than one IDs; and determining display information corresponding to more than one IDs as the associated display information.

Herein, the signal transmission source may be an iBeacon device, a non-touch hardware device that can emit information or the like. Each iBeacon device has an ID, and an ID corresponding to the iBeacon is an ID of the iBeacon device. The server uses the current geographic location of the terminal as a center, and uses an area in a range with a distance from the center as a target area. The size of the range may be set flexibly according to an actual situation. For example, an area of a circumference of 200 meters of the center is used as the target area, or an area of a circumference of 1000 meters of the center is used as the target area. Generally, in actual application, at least one store (merchant) exists in the target area, each store may have an iBeacon device, each device has an exclusive ID, and the ID of each iBeacon device is allocated by the server. After receiving the ID allocated by the server, the iBeacon device may emit the ID within a target range. For example, the iBeacon device may emit the ID within a circumference of 50 m, to spread services provided by the iBeacon device. The server may record a correspondence between each ID and a service provided by a corresponding store. The server reads the ID of each iBeacon device in the target area, and determines, according to the correspondence, a service provided by each store in the target area. The service content provided by the store may be regarded as display information. For example, an iBeacon device of a store A in the target area is an ID 1, and the device may emit the ID 1 to spread service content provided by the device. For the server, the server may learn, according to the ID 1 and the recorded correspondence, that the device provides a buy-one get-one-free service, and the display information may be a “buy-one get-one-free coupon”.

In step 503, second information from the terminal is received. The second information may include the user's basic information and/or the user's behavior information and/or the user's relation chain information, or the like.

The second information of the terminal may be or may be not stored in the server. For example, when the server receives the second information from the terminal, the server may store the second information. On the other hand, when the server receives the second information from the terminal, the server may store the second information and reads the stored second information. The ID of the terminal may be an IMEI of a subscriber identity module card inserted by the terminal, an MEID, a MAC address used by the terminal, or the like.

It should be noted that, the sequence of step 502 and step 503 is not strictly limited. Step 503 may be performed first, and then step 502 can be performed second, or step 502 and step 503 may be performed at the same time.

In step 504, the second information is analyzed to obtain an analysis result; the display information associated with the more than one ID is assessed based on the analysis result, to obtain at least one target assessed value; and the target display information is selected according to the at least one target assessed value.

Herein, the second information is information that can represent a personality of a terminal user. The server analyzes the second information, assesses each piece of display information based on an analysis result, and selects target display information according to a target assessed value obtained by means of assessment. That is, in this solution, according to a target assessed value displayed by each of multiple pieces of display information, display information that can represent a personality of a terminal user or an actual use situation is filtered.

It should be noted that, step 504 may be used as a further description of selecting target display information associated with the second information from the display information associated with the more than one ID in this solution.

The assessing the display information associated with the more than one ID based on the analysis result, to obtain at least one target assessed value includes: filtering display information that matches the analysis result from the display information associated with the more than one ID; invoking a standard assessed value corresponding to the filtered display information; and performing a first operation on the standard assessed value, to obtain an assessed value of the filtered display information, and determining the obtained assessed value as the target assessed value.

The selecting the target display information according to the at least one target assessed value includes: sequencing the at least one target assessed value in ascending order or descending order, to obtain a first sequenced result; determining a target assessed value greater than or equal to a first threshold; and determining display information corresponding to the target assessed value greater than or equal to the first threshold as the target display information.

The second information may include user basic information, user behavior information, user relation chain information, an analysis result about which store (merchant) the terminal user was once interested in, such as which store's public account the terminal user added or which store's preferential activity the terminal user participated in can be obtained by analyzing the second information. In the service content, namely, the display information, provided by each store in the target area, the analysis result is matched with the service provided by the store, such as a service of a “buy-one get-one-free activity” provided by a store A in the target area. That the terminal user once followed the store A is obtained based on analysis of the second information of the terminal user. The service provided by the store A is the display information that matches the analysis result, namely, the service provided by the store A is the display information filtered by the server. The server reads a standard assessed value. The standard assessed value is correspondingly set for the service provided by each store when the server records a correspondence between an ID and a service provided by a corresponding store. For example, both a standard assessed value of a service provided by a store 1 and a standard assessed value of a service provided by a store 2 are set to 0 or a standard assessed value of a service provided by a store 1 is set to 0, and a standard assessed value of a service 2 provided by a store 2 is set to 1. Certainly, the standard assessed value may also be set to other values, which are not described herein again. A first operation, for example, a plus/minus operation such as a plus 1/minus 1 operation, a plus 2/minus 2, or a plus 3/minus 3, or a multiply/divide operation such as a multiply 2/divide 2, or a multiply 3/divide 3, is performed on the standard assessed value. Other operations may also be performed, which are not described herein again. By using the plus 1 operation as an example, each time the server filters a piece of display information that matches the analysis result, the plus 1operation is performed on a standard assessed value corresponding to the display information, to obtain an assessed value (target assessed value) of each piece of the filtered display information. The server sequences the target assessed values in ascending order or descending order, to obtain a first sequenced result; determines a target assessed value greater than or equal to a first threshold; and determines display information corresponding to the target assessed value greater than or equal to the first threshold as the target display information. For example, display information A, display information B, and display information C are service content provided by stores A, B, and C respectively, the display information A, the display information B, the display information C are filtered display information, and target assessed values obtained through calculation are 10, 7, and 2 respectively. Assuming that the first threshold is 5, the target display information should be display information A whose target assessed value is 10 and display information B whose target assessed value is 7.

Herein, in combination with the second information that can represent a user personality, a target assessed value of each piece of display information is calculated, and display information that may meet the user personality is filtered according to the target assessed value, so that the service can be recommended precisely, and the recommendation precision can be improved and ensured.

In step 505, the target display information is sent to the terminal.

Herein, after filtering the target display information, the server provides the target display information to the terminal. Correspondingly, the terminal receives the target display information, and preferably, the terminal receives and displays the target display information.

It can be learnt from the foregoing solution that, a terminal sends, to a server, detected first information that can represent a geographic location of the terminal and detected second information that can represent a personality of a terminal user, the server determines a target area according to the geographic location of the terminal, and determines, according to an ID of an iBeacon device in the target area, services, namely, display information, provided by all stores (merchants) in the target area. The server filters, in combination with the second information that can represent the personality of the terminal user and from the determined display information, display information expected by the terminal user, namely, target display information, and feeds back the target display information to the terminal. The terminal receives and displays the target display information. The server uses an area in a range with a distance from the geographic location of the terminal as the target area, and determines display information associated with more than one ID in the target area as display information that may be initially recommended. Compared with a limited broadcast distance of an iBeacon signal in the related technology, in this solution, an area range is expanded, so that the amount of display information can increase and display content can be enriched; and target display information is filtered from the display information that may be initially recommended and in combination with the second information, namely, in combination with a user personality, to recommend the information expected by the terminal user. The recommended display information can then meet an actual requirement of the user and greatly improve the recommendation's precision and accuracy, as well as improving user experience.

### Exemplary Embodiment 3

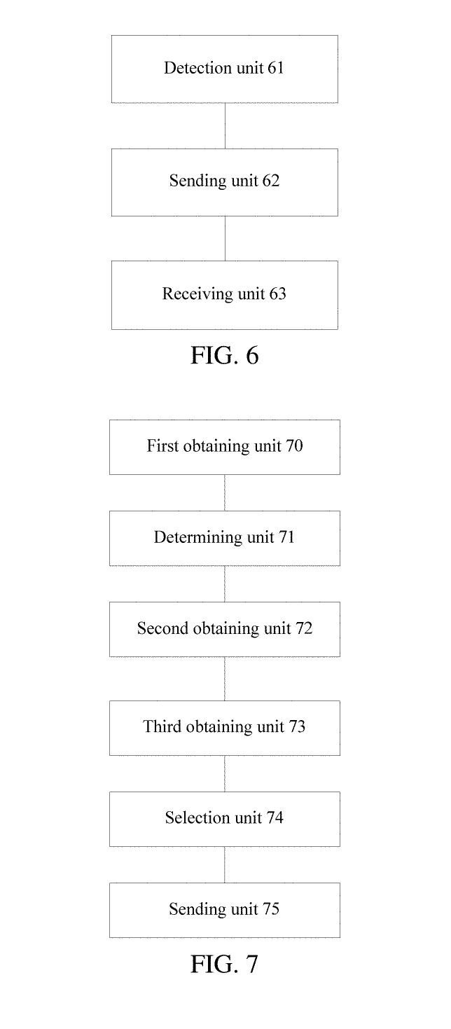

In a first exemplary embodiment of a terminal provided in the present disclosure, the terminal may include a memory, a processor, and one or more functional units that are stored in the memory and that may run in the processor. As shown in FIG. 6, the functional unit stored in the memory includes a detection unit 61, a sending unit 62, and a receiving unit 63.

The detection unit 61 is configured to detect first information of a terminal, the first information being used for representing a geographic location of the terminal.

Herein, the terminal has a geographic location detection module, and the detection unit 61 may detect a current geographic location of the terminal by using the geographic location detection module. The geographic location detection module may be specifically a GPS, a GIS, or the like.

The sending unit 62 is configured to send the first information and second information to a server, the second information may include user basic information and/or user behavior information and/or user relation chain information.

After detection unit 61 detects the first information, the sending unit 62 sends the first information and the second information to the server. The user basic information may be gender, age, occupation, and/or the like of a terminal user. The user's behavior information is information gained from the user's use of a terminal, such as following a merchant, following a public account, or participating in a scanning activity pushed by a merchant, or the like. The user relation chain information may be information that can represent a social circle of a user, such as a friend group of the user or a family group of the user.

The receiving unit 63 is configured to receive target display information sent by the server, the target display information being display information determined based on the first information and the second information.

The sending unit 62 sends the first information and the second information to the server. The server then processes the first information and the second information to obtain the target display information that the terminal expects to obtain. The receiving unit 63 receives the target display information once the server sends it.

In an exemplary embodiment, the terminal may further include a display unit, configured to display the target display information. After the terminal, the receiving unit 63 receives the target display information, the display unit displays the target display information in a preset display form. For example, the display unit directly displays the target display information and loads the target display information in a preset display template for display, such as displaying a PPT form; or may display the target display information by using social software. The display form may be any form that can be thought of by a person skilled in the art. Other display forms that can be thought of are not described again because the forms cannot be exhaustive.

A server according to the first exemplary embodiment may include a memory, a processor, and one or more functional units that are stored in the memory and that may run in the processor. As shown in FIG. 7, the functional unit stored in the memory includes: a first obtaining unit 70, a determining unit 71, a second obtaining unit 72, a third obtaining unit 73, a selection unit 74, and a sending unit 75.

The first obtaining unit 70 is configured to obtain first information from a terminal, the first information being used for representing a geographic location of the terminal.

The first obtaining unit 70 receives a current geographic location of the terminal from the terminal.

The determining unit 71 is configured to determine a target area based on the first information, the target area including more than one signal transmission source, each signal transmission source carrying an ID that represents the signal transmission source, and the ID carried in the signal transmission source being transmitted within a target range by using the signal transmission source.

The second obtaining unit 72 is configured to obtain an ID corresponding to the more than one signal transmission source in the target area and display information associated with more than one ID.

The determining unit 71 is further configured to determine, by using the geographic location as a standard area, an area whose distance from the standard area meets a first preset condition as the target area. Correspondingly, the second obtaining unit 72 is configured to determine more than one signal transmission source in the target area; determine an ID corresponding the more than one signal transmission source, to obtain more than one ID; and determine display information corresponding to the more than one ID as the associated display information.

The signal transmission source may be an iBeacon device, a non-touch hardware device that can emit information, or the like. Each iBeacon device has an ID, and an ID corresponding to the iBeacon is an ID of the iBeacon device. The server, specifically, the determining unit 71 uses the current geographic location of the terminal as a center, and uses an area in a range with a distance from the center as a target area. The size of the range may be set flexibly according to an actual situation. For example, an area of a circumference of 200 m of the center is used as the target area, or an area of a circumference of 1000 m of the center is used as the target area. Generally, in actual application, at least one store (merchant) exists in the target area, each store may have an iBeacon device, each device has an exclusive ID, and the ID of each iBeacon device is allocated by the server. After receiving the ID allocated by the server, the iBeacon device may emit the ID within a target range. For example, the iBeacon device may emit the ID within a circumference of 50 m, to spread services provided by the iBeacon device. The server may record a correspondence between each ID and service content, namely, display information, provided by a corresponding store. The server, specifically, the second obtaining unit 72 reads the ID of each iBeacon device in the target area, and determines, according to the correspondence, a service provided by each store in the target area. The service content provided by the store may be regarded as display information. For example, an iBeacon device of a store A in the target area is an ID 1, and the device may emit the ID 1 to spread service content provided by the device. For the server, the server, specifically, the second obtaining unit 72 may learn, according to the ID 1 and the recorded correspondence, that the device provides a buy-one get-one-free service, and the display information is a “buy-one get-one-free coupon”.

The third obtaining unit 73 is configured to obtain second information from the terminal, the second information at least including: user basic information and/or user behavior information and/or user relation chain information, or the like.

Herein, the second information of the terminal may be stored or may be not stored in the server. For example, the third obtaining unit 73 receives the second information from the terminal, the server may not store the second information. On the other hand, when the third obtaining unit 73 receives the second information from the terminal, the server may store the second information and read the stored second information according to an ID of the terminal. The ID of the terminal may be an IMEI of a subscriber identity module card inserted by the terminal, an MEID, or a MAC address used by the terminal, or the like. The selection unit 74 is configured to select target display information associated with the second information from the display information associated with the more than one ID.

Herein, the second information is information that can represent a personality of a terminal user. The server, specifically, the selection unit 74 filters, from multiple pieces of display information, display information (target display information) that can represent a personality of a terminal user or an actual use situation.

The sending unit 75 is configured to send the target display information to the terminal.

Herein, after the server, specifically, the selection unit 74 filters the target display information, the sending unit 75 feeds back the target display information to the terminal. Correspondingly, the terminal, specifically, the receiving unit 63 receives the target display information.

It can be taught by the foregoing solution that, a terminal sends, to a server, detected first information that can represent a geographic location of the terminal and detected second information that can represent a personality of a terminal user, the server determines a target area according to the geographic location of the terminal, and determines, according to an ID of an iBeacon device in the target area, services, namely, display information, provided by all stores (merchants) in the target area. The server filters, in combination with the second information that can represent the personality of the terminal user and from the determined display information, display information expected by the terminal user, namely, target display information, and feeds back the target display information to the terminal. The terminal receives and displays the target display information. The server uses an area in a range with a distance from the geographic location of the terminal as the target area, and determines display information associated with more than one ID in the target area as display information that may be initially recommended. Compared with a limited broadcast distance of an iBeacon signal in the related technology, in this solution, an area range is expanded, so that the amount of display information can increase and display content can be enriched; and target display information is filtered from the display information that may be initially recommended and in combination with the second information, namely, in combination with a user personality, to recommend the information expected by the terminal user. The recommended display information can then meet an actual requirement of the user and greatly improve the recommendation's precision and accuracy, as well as improving user experience.

### Exemplary Embodiment 4

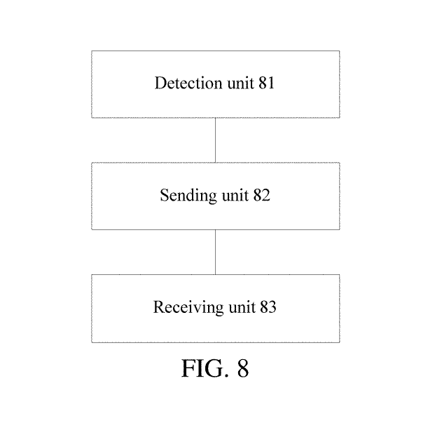

A terminal provided according to the second exemplary embodiment, the terminal may include a memory, a processor, and one or more functional units that are stored in the memory and that may run in the processor. As shown in FIG. 8, the functional unit stored in the memory includes a detection unit 81, a sending unit 82, and a receiving unit 83.

The detection unit 81 is configured to detect first information of a terminal, the first information being used for representing a geographic location of the terminal.

The detection unit 81 may detect a current geographic location of the terminal by using the geographic location detection module. The geographic location detection module may be a GPS, a GIS, or the like.

The sending unit 82 is configured to send the first information and second information to a server, the second information may include user basic information and/or user behavior information and/or user relation chain information or the like.

After detection unit 81 detects the first information, the sending unit 82 sends the first information and the second information to the server. The user basic information may include gender, age, occupation and the like of a terminal user. The user's behavior information is gained from the user's use of a terminal. The information may include, but is not limited to, the information following a merchant, a public account, and participating a scanning activity pushed by a merchant. The user relation chain information may be information that can represent a social circle of a user, such as a friend group of the user, a family group of the user, or the like.

The receiving unit 83 is configured to receive target display information from the server, the target display information being display information determined based on the first information and the second information.

The sending unit 82 sends the first information and the second information to the server. The server then processes the first information and the second information in order to obtain the target display information The receiving unit 83 receives the target display information once the server sends it.

The terminal may further include a display unit configured to display the target display information according to an exemplary embodiment. After receiving unit 83 receives the target display information, the display unit displays the target display information in a preset display form. For example, the display unit directly displays the target display information; and loads the target display information to a preset display template for display, such as displaying a PPT form; or may display the target display information by using social software. The display form may be any form that can be thought of by a person skilled in the art. Other display forms that can be thought of are not described again because the forms cannot be exhaustive.

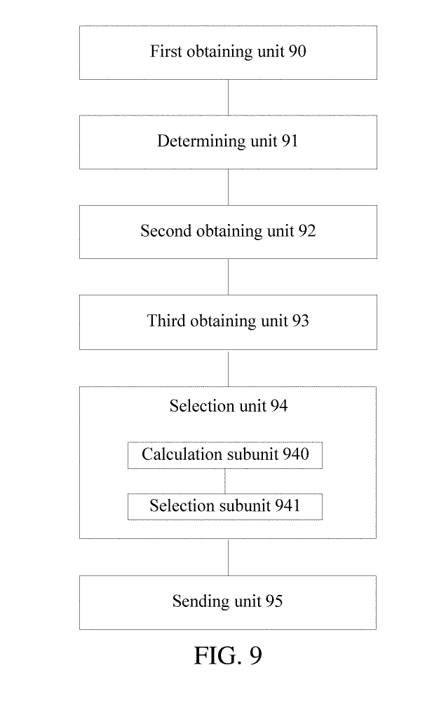

A server according to the second exemplary embodiment may include a memory, a processor, and one or more functional units that are stored in the memory and that may run in the processor. As shown in FIG. 9, the functional unit stored in the memory includes a first obtaining unit 90, a determining unit 91, a second obtaining unit 92, a third obtaining unit 93, a selection unit 94, and a sending unit 95.

The first obtaining unit 90 is configured to obtain first information from a terminal, the first information being used for representing a geographic location of the terminal.

The first obtaining unit 90 receives a current geographic location of the terminal from the terminal.

The determining unit 91 is configured to determine a target area based on the first information, the target area including more than one signal transmission source, each signal transmission source carrying an ID that represents the signal transmission source, and the ID carried in the signal transmission source being transmitted within a target range by using the signal transmission source.

The second obtaining unit 92 is configured to obtain an ID corresponding to the more than one signal transmission source in the target area and display information associated with more than one ID.

The determining unit 91 may further configure to determine, by using the geographic location as a standard area, an area where a distance from the standard area meets a first preset condition as the target area. Correspondingly, the second obtaining unit 92 is configured to determine more than one signal transmission source in the target area; determine an ID corresponding the more than one signal transmission source, to obtain more than one ID; and determine display information corresponding to the more than one ID as the associated display information.

The signal transmission source may be an iBeacon device, a non-touch hardware device that can emit information, or the like. Each iBeacon device has an ID, and an ID corresponding to the iBeacon is an ID of the iBeacon device. The server, specifically, the determining unit 91 uses the current geographic location of the terminal as a center, and uses an area in a range with a distance from the center as a target area. The size of the range may be set flexibly based on an actual situation. For example, an area of a circumference of 200 m of the center is used as the target area, or an area of a circumference of 1000 m of the center is used as the target area. Generally, in actual application, at least one store (merchant) exists in the target area, each store may have an iBeacon device, each device has an exclusive ID, and the ID of each iBeacon device is allocated by the server. After receiving the ID allocated by the server, the iBeacon device may emit the ID within a target range. For example, the iBeacon device may emit the ID within a circumference of 50 m, to spread services provided by the iBeacon device. The server may record a correspondence between each ID and service content, namely, display information, provided by a corresponding store. The second obtaining unit 92 reads the ID of each iBeacon device in the target area, and determines, according to the correspondence, services provided by each store in the target area. The service content provided by the store may be regarded as display information. For example, an iBeacon device of a store A in the target area is an ID 1, and the device may emit the ID 1 to spread service content provided by the device. The second obtaining unit 92 may learn, based on the ID 1 and the recorded correspondence, that the device provides a buy-one get-one-free service, and the display information is a “buy-one get-one-free coupon”.

The third obtaining unit 93 is configured to obtain second information from the terminal. The second information may include user basic information and/or user behavior information and/or user relation chain information, or the like.

The second information of the terminal may be or may be not stored in the server. For example, when the third obtaining unit 93 receives the second information from the terminal, the server may not store the second information. On the other hand, when the third obtaining unit 93 receives the second information from the terminal, the server may store the second information and read the stored second information. The ID of the terminal may be an IMEI of a subscriber identity module card inserted by the terminal, an MEID, a MAC address used by the terminal, or the like.

The selection unit 94 is configured to analyze the second information to obtain an analysis result; assess the display information associated with the more than one ID based on the analysis result, to obtain at least one target assessed value; and select the target display information according to the at least one target assessed value.

The second information is information that can represent a personality of a terminal user. The selection unit 94 analyzes the second information, assesses each piece of display information based on an analysis result, and selects target display information according to a target assessed value obtained by means of assessment. That is, in this solution, according to a target assessed value displayed by each of multiple pieces of display information, display information that can represent a personality of a terminal user or an actual use situation is filtered.

It should be noted that, the function of the selection unit 94 may be used as a further description of the function of the selection unit 84 for selecting target display information associated with the second information from the display information associated with the more than one ID in this solution.

The selection unit 94 may further include a calculation subunit 940 and a selection subunit 941. The calculation subunit 940 is configured to filter display information that matches the analysis result from the display information associated with the more than one ID; invoke a standard assessed value corresponding to the filtered display information; and perform a first operation on the standard assessed value, to obtain an assessed value of the filtered display information, and determine the obtained assessed value as the target assessed value. The selection subunit 941 is configured to sequence the at least one target assessed value in ascending order or descending order, to obtain a first sequenced result; determine a target assessed value greater than or equal to a first threshold; and determine display information corresponding to the target assessed value greater than or equal to the first threshold as the target display information.

The second information may include at least one of user basic information, user behavior information, or user relation chain information. The calculation subunit 940 can obtain, by analyzing the second information, an analysis result about which store (merchant) the terminal user was once interested in, such as which store's public account the terminal user added or which store's preferential activity the terminal user participated in. In the service content, namely, in the display information, provided by each store in the target area, the calculation subunit 940 matches the analysis result with the service provided by the store, such as a service of a “buy-one get-one-free activity” provided by a store A in the target area. That the terminal user once followed the store A is obtained based on analysis of the second information of the terminal user. The service provided by the store A is the display information that matches the analysis result, namely, the service provided by the store A is the display information filtered by the server. The selection unit 94 of the server, specifically, the calculation subunit 940 reads a standard assessed value. The standard assessed value is correspondingly set for the service provided by each store when the server records a correspondence between an ID and a service provided by a corresponding store. For example, both a standard assessed value of a service provided by a store 1 and a standard assessed value of a service provided by a store 2 are set to 0 or a standard assessed value of a service provided by a store 1 is set to 0, and a standard assessed value of a service 2 provided by a store 2 is set to 1. Certainly, the standard assessed value may also be set to other values, which are not described herein again. The calculation subunit 940 performs a first operation, for example, a plus/minus operation such as a plus 1/minus 1 operation, a plus 2/minus 2, or a plus 3/minus 3, or a multiply/divide operation such as a multiply 2/divide 2, or a multiply 3/divide 3, on the standard assessed value. Other operations may also be performed, which are not described herein again. By using the plus 1 operation as an example, each time the calculation subunit 940 filters a piece of display information that matches the analysis result, the calculation subunit 940 performs the plus 1 operation on a standard assessed value corresponding to the display information, to obtain an assessed value (target assessed value) of each piece of the filtered display information. The selection unit 94 of the server, specifically, the selection subunit 941 sequences the target assessed values in ascending order or descending order, to obtain a first sequenced result; determines a target assessed value greater than or equal to a first threshold; and determines display information corresponding to the target assessed value greater than or equal to the first threshold as the target display information. For example, display information A, display information B, and display information C are provided by stores A, B, and C respectively. The display information A, the display information B, the display information C are filtered display information, and target assessed values obtained through calculation by the selection subunit 941 are 10, 7, and 2 respectively. Assuming that the first threshold is 5, the target display information should be display information A whose target assessed value is 10 and display information B whose target assessed value is 7.

Herein, in combination with the second information that can represent a user personality, a target assessed value of each piece of display information is calculated, and display information that may meet the user personality is filtered according to the target assessed value, so that the service can be recommended precisely, and the recommendation precision can be improved and ensured.

The sending unit 95 is configured to send the target display information to the terminal.

The selection unit 94 filters the target display information, the sending unit 95 provides the target display information to the terminal. The terminal, the receiving unit 83 receives the target display information.

It can be learnt from the foregoing solution that, a terminal sends, to a server, detected first information that can represent a geographic location of the terminal and detected second information that can represent a personality of a terminal user, the server determines a target area according to the geographic location of the terminal, and determines, according to an ID of an iBeacon device in the target area, services, namely, display information, provided by all stores (merchants) in the target area. The server filters, in combination with the second information that can represent the personality of the terminal user and from the determined display information, display information expected by the terminal user, namely, target display information, and feeds back the target display information to the terminal. The terminal receives and displays the target display information. The server uses an area in a range with a distance from the geographic location of the terminal as the target area, and determines display information associated with more than one ID in the target area as display information that may be initially recommended. Compared with a limited broadcast distance of an iBeacon signal in the related technology, in this solution, an area range is expanded, so that the amount of display information can increase and display content can be enriched; and target display information is filtered from the display information that may be initially recommended and in combination with the second information, namely, in combination with a user personality, to recommend the information expected by the terminal user. The recommended display information can meet an actual requirement of the user, greatly improve the recommendation precision and accuracy, and improve user experience.

It may be noted that, the terminal may include, but is not limited to, a smart mobile terminal such as a mobile phone, a portable electronic device such as a PAD, a tablet computer, a handheld computer, or a PC. The server may be formed by using a cluster system, and is an electronic device that combines unit functions into one or in which unit functions are disposed separately. The terminal and the server both at least include a database configured to store data and a processor configured to process data, or include a storage medium disposed in the server or a storage medium disposed separately.

For the processor used for processing data, processing may be performed by using a microprocessor, a central processing unit (CPU), a digital signal processor (DSP), or a field-programmable gate array (FPGA). The storage medium includes an operation instruction, the operation instruction may be computer executable code, and the operation instruction is used to implement the foregoing steps in the process of the information processing method in the exemplary embodiments.

Further, there is provided a computer storage medium storing a computer program, and the computer program is used for performing the information recommendation method in the exemplary embodiments discussed herein.

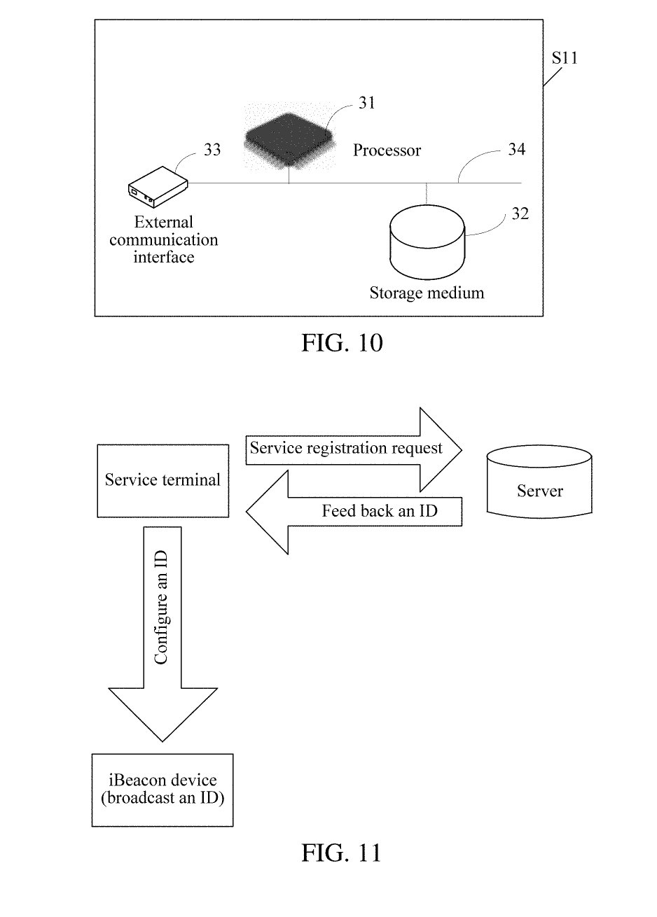

The terminal and the server are an example of a hardware entity S11. As shown in FIG. 10, both the terminal and the server include a processor 31, a storage medium 32 and at least one external communication interface 33 respectively. The terminal communicates with the server by using an external communication interface 33 respectively. In the server or the terminal, the processor 31, the storage medium 32, and the external communication interface 33 are connected by using a bus 34.

When the terminal is the hardware shown in FIG. 10, when executing the computer executable code, the processor 31 may implement at least one of the following functions: detecting first information of a terminal, the first information being used for representing a geographic location of the terminal; sending the first information and second information to a server, the second information may include user basic information and/or user behavior information and/or user relation chain information, or the like; or receiving target display information sent by the server, the target display information being display information determined based on the first information and the second information. When the server is the hardware shown in FIG. 10, when executing the computer executable code, the processor 31 may implement at least one of the following functions: obtaining first information from a terminal, the first information being used for representing a geographic location of the terminal; determining a target area based on the first information, the target area including more than one iBeacon, each iBeacon carrying an ID that represents the iBeacon, and the ID carried in the iBeacon being transmitted within a target range by using the iBeacon; obtaining an ID corresponding to the more than one signal transmission source in the target area and display information associated with more than one ID; obtaining second information from the terminal, the second information at least including: user basic information and/or user behavior information and/or user relation chain information; selecting target display information associated with the second information from the display information associated with more than one ID; or sending the target display information to the terminal.

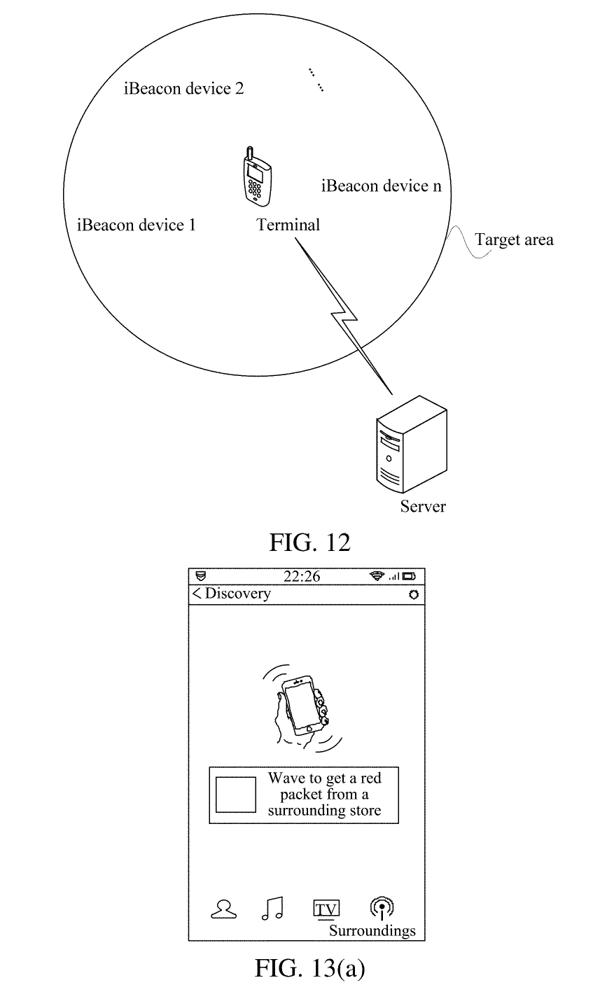

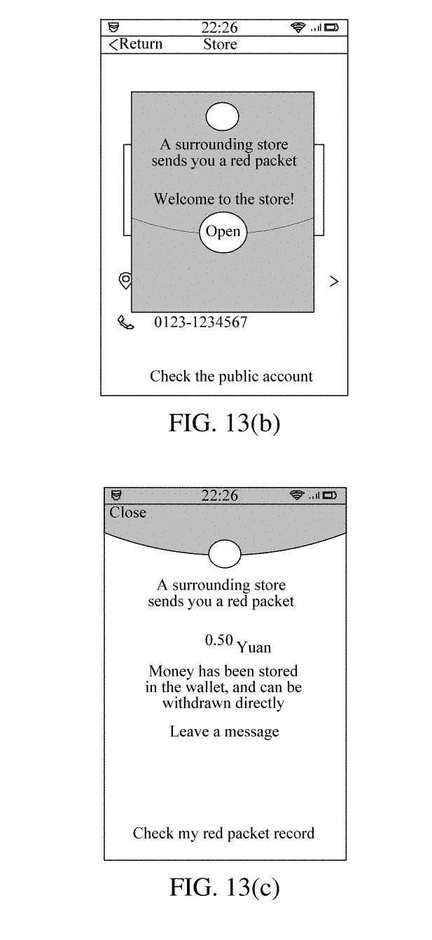

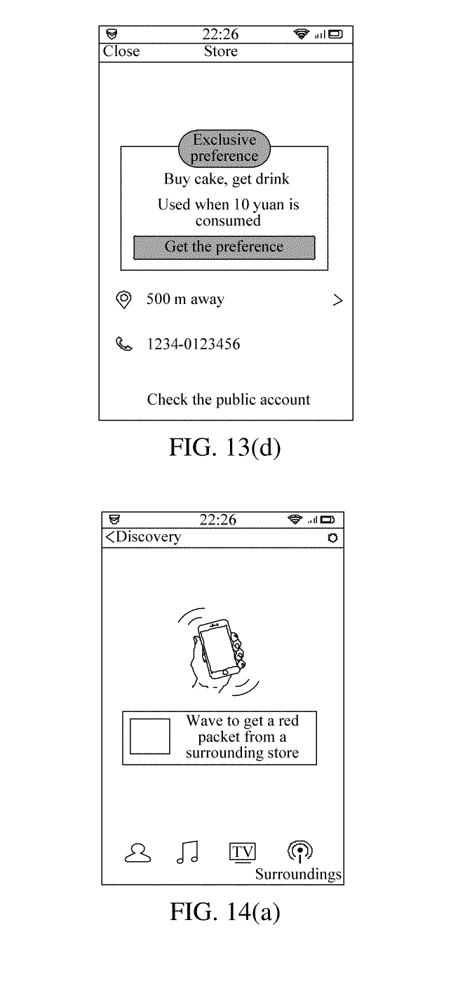

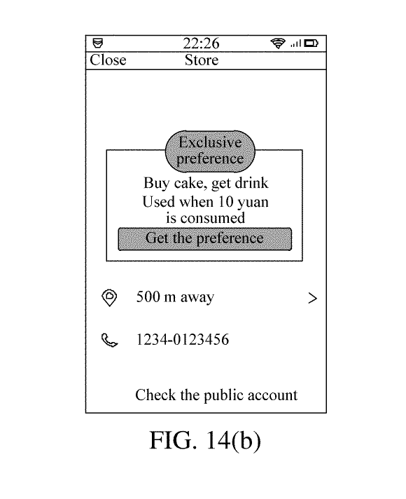

The following further describes this solution with reference to FIG. 11, FIG. 12, FIG. 13(a) to FIG. (d), and FIG. 14(a) and FIG. 14 (b).

Referring to FIG. 11, a process in which a server records a correspondence between an ID and a service, namely, display information, provided by a store in this solution is simply described. The process is implemented by using an iBeacon technology. The store provides a service, a store worker sends a service registration request to the server by using a service terminal, such as a webpage in a service terminal. When the server receives the request, an exclusive ID is generated for the service provided by the store, and the exclusive ID and the service are correspondingly recorded. The exclusive ID is returned to the terminal, the terminal presents the exclusive ID to the store worker, and the store worker configures the exclusive ID to an iBeacon device in the store. The iBeacon device may broadcast the exclusive ID outward, to inform the store which service, namely, which display information may be provided. The server may read the ID broadcast outward by each iBeacon device in a target area, to obtain IDs in the target area. The service terminal may be a mobile phone, a computer, or the like.

FIG. 12 is a schematic diagram of an application according to an exemplary embodiment. When a terminal detects a waving operation (as shown in FIG. 13(a)) generated for the terminal by a user, the terminal starts a GPS module, detects a current location by using the module, reads second information of the terminal user, and sends the detected Y location (assuming that the current location is the Y location) and the second information to the server. The server receives information about the current location of the terminal, and uses an area of a circumference of 500 m of a center of the location Y as the target area. Because the iBeacon device in each store in the target area broadcasts outward an ID that can identify the service provided by the store, the server reads the ID broadcast by each iBeacon device in the target area, and finds a corresponding service, namely, corresponding display information through research by using the ID and according to the previously recorded correspondence. It is assumed that the server finds through research that all three stores in the target area have corresponding display information. For example, a store A provides a “buy and get” service (display information A), a store B provides a “consume with a discount” service (display information B), and a store C provides “present a red packet” service (display information C). The server analyzes the received second information, namely, at least one of user basic information, user behavior information, or user relation chain information, to obtain which store the terminal user was once interested in, such as which store's public account the terminal user added or which store's preferential activity the terminal user participated in. The server matches an analysis result with the service provided by the store, finds that the terminal user once participated in preferential services of the store A and the store C, regards that the display information A and the display information C are display information that match the analysis result of the second information, invokes standard assessed values set for the display information A and the display information C, such as a standard assessed value A1 and a standard assessed value C1, and performs a plus 1 operation on the standard assessed values A1 and the standard assessed value C1, to obtain a target assessed value A2=A1+1 of the display information A, and a target assessed value C2=C1+1 of the display information C. Then, the server sequences A2 and C2. When A1 is less than C1, a sequencing result in ascending order is that C2 is greater than A2. When a first threshold is CN, and CN is greater than A2, C2 is a target assessed value greater than or equal to the first threshold, and display information C corresponding to C2 is target display information filtered by the server. The server feeds back the target display information, namely, the display information C to the terminal, and the terminal receives and displays the target display information. In this solution, an area range is expanded, so that the amount of display information can increase and display content can be enriched; and target display information is filtered from display information that may be initially recommended and in combination with the second information, namely, in combination with a user personality, to recommend information expected by the terminal user. The recommended display information can meet an actual requirement of the user, greatly improve the recommendation precision and accuracy, and improve user experience.

As shown in FIG. 13(a), FIG. 13(a) is a first display interface presented by a terminal by using social software. A row of icons are at the lowest side of the display interface, and the rightmost icon represents a “surrounding” function. When the terminal starts the function, and detects a waving operation generated by a user for the terminal, the terminal sends a geographic location of the terminal and second information of the terminal user to a server. The server filters the display information in the target area according to the foregoing solution, to obtain target display information, and feeds back the filtered target display information to the terminal.

For example, if the target display information filtered by the server is “present a red packet”, the terminal displays third information on a preset area on the first display interface shown in FIG. 13(a). The third information is used for representing surrounding target display information found through research by using the “surrounding” function, such as the “present a red packet” service. When the terminal detects a touch-control operation of the user for the third information, such as a single click, double clicks, or a click in preset times, the terminal presents a second display interface shown in FIG. 13(b). The second display interface presents an interaction object such as “open”. When detecting an operation of the interaction object, such as a single click, double clicks, or another operation that can be thought out, the terminal presents a third display interface shown in FIG. 13(c). The third display interface displays the amount of the red packet and a reminding message such as the amount has been stored in the “wallet”, leaving a message for the store, checking the red packet record, or the like. If the terminal user is interested in a merchant that presents a red packet, the terminal user may directly perform an operation such as a click or double clicks on the interaction object such as “follow” on the upper right corner of the third display interface, so as to enter a merchant interface (store interface). If the merchant further pushes another service, the merchant displays another service such as a “buy cake, get drink” service in FIG. 13(d) on the merchant interface, for the terminal user to select whether to enjoy the service of the merchant.

If the target display information filtered by the server is another service such as a “buy and get” service except “present a red packet”, different from the first display interface in FIG. 13(a), as shown in FIG. 14(a), a preset area of a first display interface displays fourth information. The fourth information is used for representing surrounding target display information such as a “buy and get” service found through research by using the “surrounding” function. When the terminal detects a touch-control operation of a user for the fourth information, such as a single click, double clicks, or a click in preset times, the terminal presents a merchant interface shown in FIG. 14(b), and displays specific content of the “buy and get” service such as “buy cake, get drink” on the merchant interface, for the terminal user to select whether to enjoy the service of the merchant.

As described above, in this solution, the terminal may display the target display information by using social software, thereby enriching an effect of information display, and making information display more interesting. In addition, displaying the merchant interface facilitates viewing of the user for a preferential service, facilitates user life, and improves experience of the terminal user.

A person skilled in the art should understand that the exemplary embodiments discussed herein may be provided as a method, a system, or a computer program product. Therefore, the present disclosure may take the form of hardware embodiments, software embodiments, or embodiments combining software and hardware. Moreover, the present disclosure may use a form of a computer program product that is implemented on one or more computer-usable storage media (including but not limited to a disk memory, an optical memory, and the like) that include computer-usable program code.

The example embodiments discussed herein are described with reference to flowcharts, block diagrams, devices and/or systems, and computer program products. It should be understood that computer program instructions may be used to implement each process and/or each block in the flowcharts and/or the block diagrams and a combination of a process and/or a block in the flowcharts and/or the block diagrams. These computer program instructions may be installed in a general-purpose computer to convert the general-purpose computer into a specific-purpose computer that operates are explained herein. These computer program instructions may also be provided for a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may further be stored in a computer readable memory that can instruct the computer or any other programmable data processing device to work in a specific manner, so that the instructions stored in the computer readable memory generate an artifact that includes an instruction apparatus. The instruction apparatus implements a specified function in one or more processes in the flowcharts and/or in one or more blocks in the block diagrams.

These computer program instructions may further be loaded onto a computer or another programmable data processing device, so that a series of operations and steps are performed on the computer or the other programmable device, thereby generating computer-implemented processing. Therefore, the instructions executed on the computer or the other programmable device provide steps for implementing a specific function in one or more processes in the flowcharts and/or in one or more blocks in the block diagrams.

The foregoing descriptions are merely preferred exemplary embodiments, but are not used to limit the protection scope of any particular claim.

What is claimed is:

1. A method performed by at least one computer processor, the method comprising:
obtaining first information from a terminal, the first information being used for representing a geographic location of the terminal;
determining a target area based on the first information, the target area comprising more than one signal transmission sources each including an ID that represents the signal transmission source, and the ID included in the signal transmission source being broadcasted within a target range by using the signal transmission source;
obtaining more than one ID corresponding to the more than one signal transmission sources in the target area and displaying information associated with more than one ID;
obtaining second information from the terminal, the second information comprising at least one of user basic information and user behavior information and user relation chain information;
selecting target display information associated with the second information from the display information associated with the more than one ID; and
sending the target display information to the terminal.

2. The method according to claim 1, by at least one computer processor, further comprising:
analyzing the second information to obtain an analysis result;
assessing the display information associated with the more than one ID based on the analysis result, to obtain at least one target assessed value; and
selecting the target display information based on the at least one target assessed value.

3. The method according to claim 2, by at least one computer processor, further comprising:
sequencing the at least one target assessed value in ascending order or descending order, to obtain a first sequenced result;
determining a target assessed value greater than or equal to a first threshold; and
determining display information corresponding to the target assessed value greater than or equal to the first threshold as the target display information.

4. The method according to claim 2, by at least one computer processor, further comprising:
filtering display information that matches the analysis result from the display information associated with the more than one ID;
invoking a standard assessed value corresponding to the filtered display information; and
performing a first operation on the standard assessed value, to obtain an assessed value of the filtered display information, and determining the obtained assessed value as the target assessed value.

5. The method according to claim 1, by at least one computer processor, further comprising:
determining, by using the geographic location as a standard area, an area where a distance from the standard area meets a first preset condition as the target area;
determining more than one signal transmission source in the target area;
determining obtain more than one ID corresponding to the more than one signal transmission source, to obtain more than one ID; and
determining display information corresponding to the more than one ID as the associated display information.

6. A system comprising:
one or more terminals; and
a server,
wherein each of the one or more terminals comprise:
at least one terminal memory configured to access the at least one terminal memory and operate according to the terminal computer program code, the terminal computer program code including:
detecting code configured to cause at least one of the least one terminal processor to detect first information for representing a geographic location of the terminal;
sending code configured to cause at least one of the least one terminal processor to send the first information and second information to the server, the second information comprising at least one of user basic information, user behavior information, and user relation chain information; and
receiving code configured to cause at least one of the least one terminal processor to receive target display information from the server, the target display information being display information determined based on the first information and the second information, and
wherein the server comprises:
at least one server memory configured to store server computer program code; and
at least one server processor configured to access the at least one server memory and operate according to the server computer program code, said server computer program code including:
first obtaining code configured to cause the at least one processor to obtain first information from a terminal, the first information being used for representing a geographic location of the terminal;
determining code configured to cause the at least one processor to determine a target area based on the first information, the target area comprising more than one signal transmission source, each signal transmission source including an ID that represents the signal transmission source, and the ID included in the signal transmission source being broadcasted within a target range by using the signal transmission source;
second obtaining code configured to cause the at least one processor to obtain more than one ID corresponding to the more than one signal transmission source in the target area and display information associated with more than one ID;
third obtaining code configured to cause the at least one processor to obtain second information from the terminal, the second information comprising at least one of user basic information and user behavior information and user relation chain information;
selection code configured to cause the at least one processor to select target display information associated with the second information from the display information associated with the more than one ID; and
sending code configured to cause the at least one processor to send the target display information to the terminal.

7. The system according to claim 6, wherein the server computer code further comprises:
assessing code configured to cause the at least one processor
to assess the display information associated with the more than one ID based on the analysis result,
to obtain at least one target assessed value; and
selecting code configured to cause the at least one processor to select the target display information based on the at least one target assessed value.

8. The system according to claim 7, wherein the selecting code is further configured to cause the at least one processor to:
sequence the at least one target assessed value in ascending order or descending order, to obtain a first sequenced result;
determine a target assessed value greater than or equal to a first threshold; and
determine display information corresponding to the target assessed value greater than or equal to the first threshold as the target display information.

9. The system according to claim 7, wherein the server computer program code further comprises:
calculation code configured to cause the at least one processor to: filter display information that matches the analysis result from the display information associated with the more than one ID;
invoke a standard assessed value corresponding to the filtered display information; and
perform a first operation on the standard assessed value, to obtain an assessed value of the filtered display information, and determine the obtained assessed value as the target assessed value.

10. The system according to claim 6, wherein the determining code is further configured to cause the at least one processor to:
determine, by using the geographic location as a standard area, an area whose distance from the standard area meets a first preset condition as the target area;
determine more than one signal transmission source in the target area;
determine more than one ID corresponding the more than one signal transmission source, to obtain more than one ID; and
determine display information corresponding to the more than one ID as the associated display information.

11. The system according to claim 8, wherein the server computer program code further comprises:
calculation code configured to cause the at least one processor to:
filter display information that matches the analysis result from the display information associated with the one or more ID;
invoke a standard assessed value corresponding to the filtered display information; and
perform a first operation on the standard assessed value, to obtain an assessed value of the filtered display information, and determine the obtained assessed value as the target assessed value.

12. A server comprising:
at least one memory configured to store computer program code; and
at least one processor configured to access the at least one memory and operate according to the computer program code, said computer program code including:
first obtaining code configured to cause the at least one processor to obtain first information from a terminal, the first information being used for representing a geographic location of the terminal;
determining code configured to cause the at least one processor to determine a target area based on the first information, the target area comprising more than one signal transmission source each including an ID that represents the signal transmission source, and the ID included in the signal transmission source being broadcasted within a target range by using the signal transmission source;
second obtaining code configured to cause the at least one processor to obtain an ID corresponding to the more than one signal transmission source in the target area and display information associated with more than one ID;
third obtaining code configured to cause the at least one processor to obtain second information from the terminal, the second information comprising at least one of user basic information and user behavior information and user relation chain information;
selection code configured to cause the at least one processor to select target display information associated with the second information from the display information associated with the more than one ID; and
sending code configured to cause the at least one processor to send the target display information to the terminal.

13. The server according to claim 12, wherein the computer program code further comprises:
assessing code configured to cause the at least one processor
to assess the display information associated with the more than one ID based on the analysis result,
to obtain at least one target assessed value; and
selecting code configured to cause the at least one processor to select the target display information based on the at least one target assessed value.

14. The server according to claim 13, wherein the selecting code is further configured to cause the at least one processor to:
sequence the at least one target assessed value in ascending order or descending order, to obtain a first sequenced result;
determine a target assessed value greater than or equal to a first threshold; and
determine display information corresponding to the target assessed value greater than or equal to the first threshold as the target display information.

15. The server according to claim 13, wherein the computer program code further comprises:
calculation code configured to cause the at least one processor to: filter display information that matches the analysis result from the display information associated with the more than one ID;
invoke a standard assessed value corresponding to the filtered display information; and
perform a first operation on the standard assessed value, to obtain an assessed value of the filtered display information, and determine the obtained assessed value as the target assessed value.

16. The server according to claim 12, wherein the determining code is further configured to cause the at least one processor to:
determine, by using the geographic location as a standard area, an area whose distance from the standard area meets a first preset condition as the target area;
determine more than one signal transmission source in the target area;
determine more than one ID corresponding the more than one signal transmission source, to obtain more than one ID; and
determine display information corresponding to the more than one ID as the associated display information.
